(19) United States
(12) Patent Application Publication
(10) Pub. No.: US 2026/0217032 A1
(43) Pub. Date: Jul. 30, 2026

(54) NOZZLE PROTECTIVE CAP, HEAD UNIT, AND METHOD OF ATTACHING NOZZLE PROTECTIVE CAP

(71) Applicant: BROTHER KOGYO KABUSHIKI KAISHA, Nagoya (JP)

(72) Inventor: Takashi ISHIDA, Nagoya (JP)

(73) Assignee: BROTHER KOGYO KABUSHIKI KAISHA, Nagoya (JP)

(21) Appl. No.: 19/629,042

(22) Filed: Mar. 26, 2026

Related U.S. Application Data
(63) Continuation of application No. PCT/JP2025/001854, filed on Jan. 22, 2025.

(30) Foreign Application Priority Data
Jan. 31, 2024 (JP) 2024-013275

(51) Int. Cl. B41J 2/165

(52) U.S. Cl. CPC B41J 2/16505

(57) ABSTRACT

A nozzle protective cap includes a base part, a seal member, a first engaging part, and a second engaging part. The base part has a facing surface configured to face a nozzle surface of a recording head. The seal member is positioned in the facing surface and includes an elastic member configured to press the nozzle surface. The first engaging part is configured to press the seal member against the nozzle surface and to engage with the recording head so that the nozzle protective cap and the recording head are integrated. The second engaging part is configured to press the seal member against the nozzle surface and to engage with the recording head to an extent stronger than the first engaging part engages with the recording head so that the nozzle protective cap and the recording head are integrated.

### REFERENCE TO RELATED APPLICATIONS

This application is a Continuation Application of International Application No. PCT/JP2025/001854 filed on January 22, 2025 that claims the conventional priority of Japanese patent Application No. 2024-013275 filed on January 31, 2024. The entire content of Japanese patent Application No. 2024-013275 and the entire content of International Application No. PCT/JP2025/001854 are incorporated herein by reference.

### BACKGROUND ART

A cap for a recording head is known. The known cap for the recording head is configured to hermetically seal an ink ejection port of an ink-jet recording head. The known cap can be attached and detached with respect to a main body of the ink-jet recording head. In the known cap, in a case where the cap for the recording head is attached to the main body, the cap for the recording head is attached by using an engaging pawl which is included by the cap for the recording head. However, a conventional cap for a recording head is also known, in which the cap for the recording head is attached to the main body by using a screw.

### SUMMARY

However, in a case where the cap is required to be attached and detached with respect to the main body repeatedly and frequently, the conventional cap, in which the cap for the recording head is attached to the main body by using the screw, an operation of fastening the screw and an operation of unfastening the screw need to be performed every time in a case where the conventional cap is attached and detached. Such operations have been troublesome. On the other hand, in a case where the cap is attached by using the engaging pawl, the cap is unexpectedly unfastened in some cases, for example, in a case where the ink is initially introduced and/or in a case where the recording head is conveyed. Due to this, the ink ejection port might be damaged and/or a part around the ink-jet ejection port might be dirtied due to the leaked ink.

An object of the present application is to provide a technique by which a nozzle protective cap is fixed to a heat unit in a case, for example, where the ink is initially introduced and/or in a case where the recording head is conveyed, and by which the nozzle protective cap is easily attached and detached with respect to the head unit in a case where the nozzle protective cap is required to be attached and detached with respect to the head unit repeatedly and frequently.

A nozzle protective cap of the present application includes a base part, a seal member, a first engaging part, and a second engaging part. The base part has a facing surface configured to face a nozzle surface of a recording head having a nozzle array configured to eject liquid droplets. The seal member is positioned in the facing surface and includes an elastic member configured to press the nozzle surface in a state that the seal member surrounds the nozzle array. The first engaging part is configured to press the seal member against the nozzle surface and to engage with the recording head so that the nozzle protective cap and the recording head are integrated. The second engaging part is configured to press the seal member against the nozzle surface and to engage with the recording head to an extent stronger than the first engaging part engages with the recording head so that the nozzle protective cap and the recording head are integrated.

A head unit of the present application is configured so that the nozzle protective cap as defined above can be attached and detached with respect to the head unit. The head unit includes: a recording head having the nozzle surface; a nozzle guide which has a contact surface configured to contact the facing surface of the nozzle protective cap and which surrounds the nozzle surface of the recording head; and a first engagement receiving part which is configured to engage with the first engaging part.

A method of attaching a nozzle protective cap of the present application is a method of attaching the nozzle protective cap to a head unit so that the nozzle protective cap can be attached and detached with respect to the head unit. The nozzle protective cap is configured to be attached and detached with respect to the head unit, and the nozzle protective cap includes: a base part which has a facing surface configured to face a nozzle surface of a recording head including a nozzle array configured to eject liquid droplets; a seal member which is positioned in the facing surface and which includes an elastic member configured to press the nozzle surface in a state that the seal member surrounds the nozzle array; a first engaging part which is configured to press the seal member against the nozzle surface and to engage with the recording head so that the nozzle protective cap and the recording head are integrated; and a second engaging part which is configured to press the seal member against the nozzle surface and to engage with the recording head to an extent stronger than the first engaging part engages with the recording head so that the nozzle protective cap and the recording head are integrated. The head unit includes a recording head which has the nozzle surface, a nozzle guide which has an contact surface configured to contact the facing surface of the nozzle protective cap and which surrounds the nozzle surface of the recording head, and a first engagement receiving part which is configured to engage with the first engaging part. The method of attaching the nozzle protective cap of the present application includes holding the first engaging part and the first engagement receiving part by a force of 40N or more so that the first engaging part and the first engagement receiving part are attracted to each other.

According to the present application, the nozzle protective cap can be fixed to the head unit by using the second engaging part, for example, in a case where the ink is initially introduced and/or in a case where the head unit is conveyed. In the case where the nozzle protective cap is required to be attached and detached repeatedly and frequently with respect to the head unit, the nozzle protective cap can be easily attached and detached by using the first engaging part.

### BRIEF DESCRIPTION OF DRAWINGS

FIG. 1 is a perspective view depicting the appearance of a head unit to which a nozzle protective cap according to an embodiment of the present application is attached.

FIG. 2 is a perspective view depicting a state that the nozzle protective cap depicted in FIG. 1 is detached from the head unit.

FIG. 3 is a perspective view of the state depicted in FIG. 2 as seen from a right rear position of the head unit.

### DESCRIPTION

An embodiment of the present application will be described in detail below based on the drawings. The drawings, which are used in the following description, are depicted such that a part of the basic configuration is omitted, in some cases. For example, the dimension ratios of the respective parts depicted in the drawings are not necessarily accurate. In the respective drawings, a front-rear direction D1, an up-down direction D2, and a left-right direction D3 are as depicted in the respective drawings.

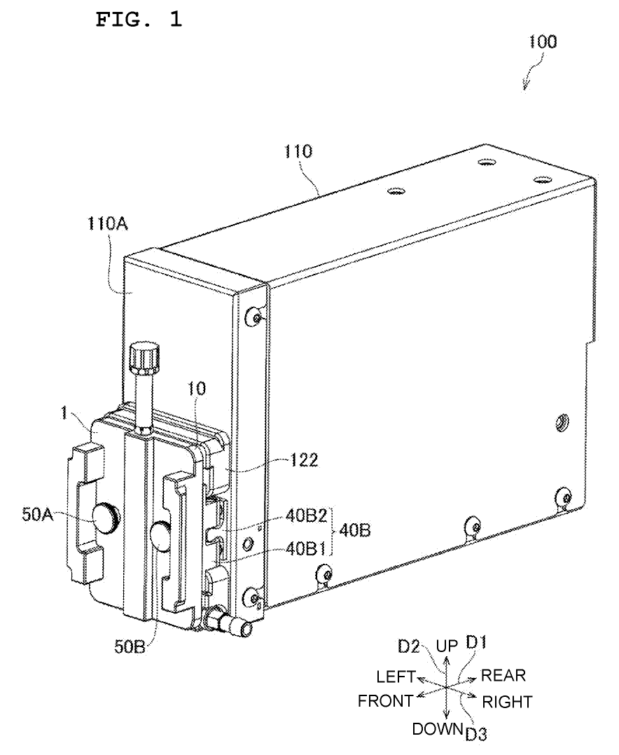

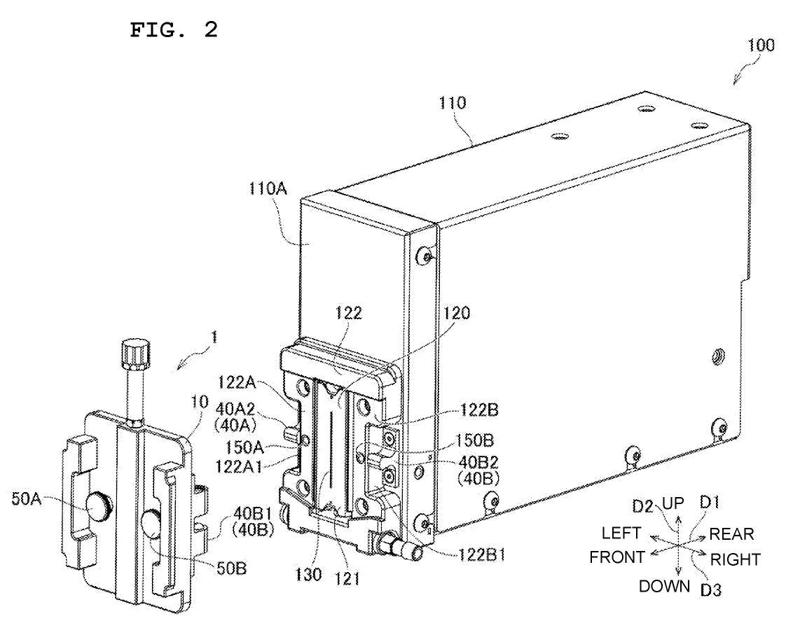

FIG. 1 depicts the appearance of a head unit 100 to which a nozzle protective cap 1 according to the embodiment of the present application is attached. The head unit 100 ejects ink from a recording head 120 (see FIG. 2) to record (print) a letter, a figure, etc., on a recording medium located at a position at which the recording medium faces the recording head 120. As depicted in FIG. 1, the head unit 100 includes a head unit casing 110 having a rectangular parallelepiped shape. The recording head 120 is disposed in the head unit casing 220, at an area ranging from a central part to a lower part of a front surface 110A of the head unit casing 110.

The nozzle protective cap 1 is configured to cover the entirety of the recording head 120. The nozzle protective cap 1 protects the recording head 120, especially a nozzle array 130 (see FIG. 2) formed in the recording head 120, from the shock exerted from the outside, the adhesion of dust, etc. Further, the nozzle protective cap 1 is attached to the recording head 120 in a case where the printing operation is not performed by the recording head 120. The reason for this is as follows. That is, in addition that the nozzle protective cap 1 protects the nozzle array 130 as described above, the nozzle protective cap 1 is attached to the recording head 1 while a maintenance operation of the recording head 120 is (being) performed so as to prevent the surroundings of the location at which the recording head 120 is installed from being dirtied by the ink. The surroundings would be otherwise dirtied, for example, due to any unexpected ejection of the ink to the outside in a case where the ink is initially introduced to the recording head 120 and/or where a purge operation is (being) performed. Note that in the present embodiment, UV ink as ink of ultraviolet-curable type is used as the ink to be ejected from the recording head 120. Therefore, in a case where the printing operation is not performed, the nozzle protective cap 1 is attached to cover the surroundings of the nozzle array 130 so that the UV ink is not exposed to the external light including the ultraviolet light via the nozzle array 130. Further, the UV ink has such a property that the gas such as oxygen, etc., contained in the air is easily dissolved in the UV ink. On this account, in a case where the UV ink is left to stand for a long time in a state that the UV ink is in contact with the air, the gas such as oxygen, etc., contained in the air is dissolved in the UV ink. The more increased the dissolved gas contained in the ink is, the more deteriorated the printing quality is. Therefore, in a case where the printing operation is not performed, the ink remaining in the nozzle array 130 needs to be prevented from contact with the air as much as possible. On this account, in a case where the printing operation is not performed, the nozzle protective cap 1 is attached to the recording head 120 so that the ink inside the nozzle array 130 is prevented from contacting the air as much as possible. In this way, in addition that the nozzle protective cap 1 serves to protect the nozzle array 130, for example, from any shock exerted from the outside, the nozzle protective cap 1 also serves to prevent the surroundings from being dirtied by the leaked ink, prevent the ink from being unexpectedly solidified, and to reduce the dissolved gas in the ink.

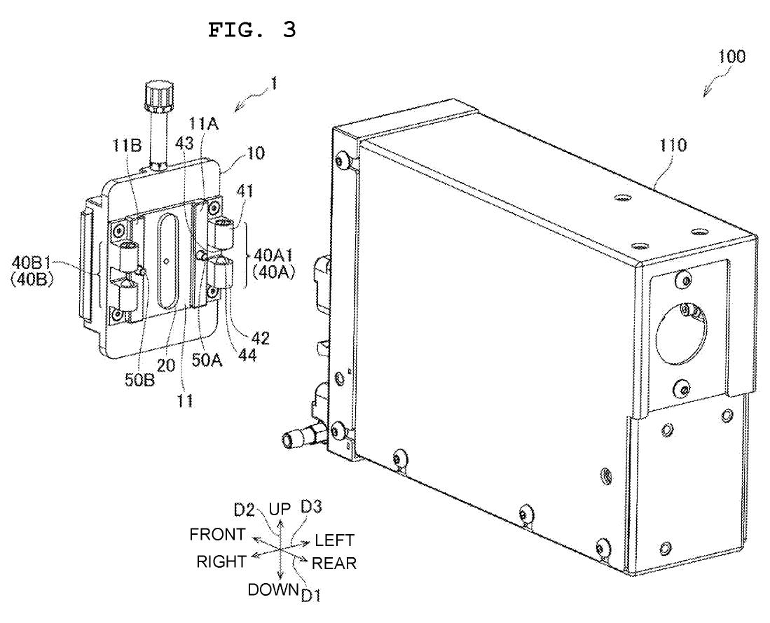

Next, the attachment structure by which the nozzle protective cap 1 is attached to the recording head 120 will be described based on FIG. 2 and FIG. 3. FIG. 2 indicates a state that the nozzle protective cap 1 is detached from the head unit 100 depicted in FIG. 1, illustrating the attachment structure in the recording head 120. FIG. 3 indicates the state that the nozzle protective cap 1 depicted in FIG. 2 is detached from the head unit 100, as seen from a right rear position of the head unit 100, illustrating the attachment structure in the nozzle protective cap 1.

As depicted in FIG. 2, the recording head 120 has a nozzle surface 121 having a substantially rectangular shape. The nozzle array 130, which is constructed of a plurality of nozzles, is formed in the up-down direction at a central part of the nozzle surface 121. Further, a nozzle guide 122 is formed to surround the nozzle surface 121. The nozzle guide 122 has contact surfaces 122A, 122B which are formed in a direction in which the nozzle array 130 extends, i.e., in the up-down direction; the contact surfaces 122A and 122B are formed, respectively, on both the left and right sides so that the nozzle surface 121 is interposed therebetween. As described later with reference to FIG. 3, in a case where the nozzle protective cap 1 is attached to the recording head 120, the contact surfaces 122A, 122B are surfaces to which a facing surface 11 of the nozzle protective cap 1 is brought into contact, in particular, to which protrusions 11A, 11B, respectively, of the facing surface 11 is brought into contact.

A cutout 122A1 is formed to range over, in the up-down direction, from the central part at the left end of the left contact surface 122A, and a cutout 122B1 is formed to range over, in the up-down direction, from the central part at the right end of the right contact surface 122B. Further, an engagement receiving part 40A2, which constructs a left ball catch 40A of a pair of ball catches 40A, 40B, is screw-fastened to a portion at which the front surface 110A of the head unit casing 110 is exposed by the cutout 122A1. On the other hand, an engagement receiving part 40B2, which constructs the right ball catch 40B of the pair of ball catches 40A, 40B, is screw-fastened to a portion at which the front surface 110A of the head unit casing 110 is exposed by the cutout 122B1. Each of forward ends of the engagement receiving parts 40A2, 40B2 protrudes from one of the contact surfaces 122A, 122B corresponding thereto in a direction in which the liquid droplets of the ink are ejected from the recording head 120, i.e., in the front direction in FIG. 2. Note that the engagement receiving parts 40A2, 40B2 of the pair of ball catches 40A, 40B are an example of the "first engagement receiving part".

Further, a nut 150A, which is configured to fasten a left bolt 50A of a pair of bolts 50A, 50B disposed in the nozzle protective cap 1, is embedded at a central part of the left contact surface 122A. On the other hand, a nut 150B, which is configured to fasten the right bolt 50B of the pair of bolts 50A, 50B disposed in the nozzle protective cap 1, is embedded at a central part of the right contact surface 122B. Note that the pair of bolts 50A, 50B are an example of the "second engaging part", and the pair of nuts 150A, 150B are an example of the "second engagement receiving part".

As depicted in FIG. 3, the nozzle protective cap 1 includes a base part 10 which has a facing surface 11 capable of facing the nozzle surface 121 of the recording head 120. The base part 10 has a substantially rectangular shape, and the base part 10 is set to have a size to cover the entirety of the nozzle guide 122, i.e., the entirety of the recording head 120. A seal member 20, which includes an elastic member capable of pressing the nozzle surface 121 in a state that the seal member 20 surrounds the nozzle array 130, is attached on the facing surface 11. The seal member 20 can be exemplified, for example, by a member which is formed to have a substantially rectangular shape obtained by connecting both ends of a string-shaped silicon rubber material. The material of the seal member 20 is not limited to the silicon rubber and may be any other material on condition that the seal member 20 is an elastic member. The shape of the seal member 20 is not limited to the substantially rectangular shape, and may be any other shape including, for example, an elliptic shape on condition that the nozzle array 130 can be surrounded by the seal member 20.

Further, a pair of plate-shaped protrusions 11A, 11B are formed, respectively, at both left and right ends of the facing surface 11. In other words, the pair of protrusions 11A, 11B are disposed, respectively, at positions at which the seal member 20 is interposed between the pair of protrusions 11A, 11B in a direction parallel to the facing surface 11. Furthermore, the shaft part of the bolt 50A is exposed from the central part in the up-down direction of the protrusion 11A; and the shaft part of the bolt 50B is exposed from the central part in the up-down direction of the protrusion 11B.

An engaging part 40A1, which constructs the left ball catch 40A of the pair of ball catches 40A, 40B, is screw-fastened on the base part 10, at a location outside the left end of the facing surface 11. On the other hand, an engaging part 40B1, which constructs the right ball catch 40B of the pair of ball catches 40A, 40B, is screw-fastened on the base part 10, at a location outside the right end of the facing surface 11. Note that the engaging parts 40A1, 40B1 of the pair of ball catches 40A, 40B are an example of the "first engaging part".

Since the engaging parts 40A1, 40B1 have the same configuration, the configuration of the left engaging part 40A1 will be described, whereas the configuration of the right engaging part 40B1 will be omitted. The engaging part 40A1 has a pair of housings 41, 42 which are disposed while being separated from each other in the up-down direction. A ball 43 which has a part exposed to the outside from the lower surface of the upper housing 41, and a spring (not depicted) which urges the ball 43 downward are included in the upper housing 41. A ball 44 which has a part exposed to the outside from an upper surface of the lower housing 42, and a spring (not depicted) which urges the ball 44 upward are included in the lower housing 42. Further, the left engagement receiving part 40A2 can be inserted into the space between the upper ball 43 and the lower ball 44 of the left engaging part 40A1. Accordingly, the engagement using the left ball catch 40A is completed. In a similar manner, the right engagement receiving part 40B2 can be inserted into the space between the upper ball 43 and the lower ball 44 of the right engaging part 40B1. Accordingly, the engagement using the right ball catch 40B is completed as well. Note that each of the balls 43, 44 has a ball diameter which is, for example, in a range of 3 mm to 10 mm. In a case where the ball catches 40A, 40B having the balls 43, 44 of the size of the foregoing extent are used, the nozzle protective cap 1 and the recording head 120 can be held in a hermetically sealed state by the appropriate force, and the sizes of the entire ball catches 40A, 40B can be restricted. Thus, the nozzle protective cap 1 which is compact can be produced.

Such a case is assumed that the engagement of the nozzle protective cap 1 with the recording head 120 is completed by using the pair of ball catches 40A, 40B, and then the nozzle protective cap 1 is desired to be engaged with the recording head 120 further by a stronger force. In this case, the pair of bolts 50A, 50B are rotated respectively to thereby fasten the respective bolts 50A, 50B, respectively, to the nuts 150A, 150B. In this regard, an attachment mode wherein the nozzle protective cap 1 is attached to the recording head 120 by using only the pair of ball catches 40A, 40B, is referred to as "first attachment mode". An attachment mode wherein, after the above-described attachment by the first attachment mode, the nozzle protective cap 1 is attached to the recording head 120 further by using the pair of bolts 50A, 50B is referred to as "second attachment mode". In the first attachment mode, the engagement receiving parts 40A2, 40B2 and the engaging parts 40A1, 40B1 which construct the pair of ball catches 40A, 40B are held to be in the attachment state, for example, by the force of 40 N or more in which the engagement receiving parts 40A2, 40B2 and the engaging parts 40A1, 40B1 are attracted to one another. On the other hand, in the second attachment mode, the holding force based on the pair of bolts 50A, 50B and the nuts 150A, 150B is added to the holding force of 40N or more which is based on the pair of ball catches 40A, 40B. Owing to this, the nozzle protective cap 1 and the recording head 120 are held in the attachment state further by the force stronger than the holding force in the first attachment mode.

The user can freely select either the first attachment mode or the second attachment mode. In a case where the printing with the recording head 120 is not executed continuously, the user selects the first attachment mode to attach the nozzle protective cap 1 to the recording head 120. In a case where the user selects the first attachment mode, the user can easily attach the nozzle protective cap 1 to the recording head 120 by merely pressing the nozzle protective cap 1 into the recording head 120. Further, the user can easily detach the nozzle protective cap 1 from the recording head 120 by merely pulling the nozzle protective cap 1 out of the recording head 120. In this way, the user can easily attach and detach the nozzle protective cap 1 with respect to the recording head 120 by selecting the first attachment mode.

On the other hand, for example, in a case where the head unit 100 needs to be conveyed, any shock, etc., might be exerted from the outside on the nozzle array 130 of the recording head 120, in some cases. Further, for example, in a case where the ink is initially introduced, the sealing performance for the nozzle array 130 effected by the seal member 20 is desired to be enhanced so that the air is not dragged from the outside, in some cases. In these situations, the user selects the second attachment mode to attach the nozzle protective cap 1 to the recording head 120. By doing so, the nozzle protective cap 1 is attached to the recording head 120 by a force stronger than the force in the first attachment mode. Since the nozzle protective cap 1 is not easily detached from the recording head 120, the nozzle array 130 of the recording head 120 is protected by the nozzle protective cap 1 from, for example, the shock exerted from the outside.

Note that in a case where the user selects the second attachment mode to attach the nozzle protective cap 1 to the recording head 120, the seal member 20 is pressed against the nozzle surface 121 by an excessive force. Accordingly, the seal member 20 might be elastically deformed excessively in some cases. In this regard, the pair of protrusions 11A, 11B are included in order to prevent the seal member 20 from being elastically deformed excessively. Each of the pair of protrusions 11A, 11B has a predetermined height from the facing surface 11. The seal member 20 also has a predetermined height from the facing surface 11. Further, the seal member 20 is set such that the height of the apex of the seal member 20 is higher than the height of each of the pair of protrusions 11A, 11B. Therefore, even in a case where the seal member 20 is pressed against the nozzle surface 121 by any excessive force, the seal member 20 is elastically deformed, at the maximum, by an extent corresponding to the difference between the height of the apex of the seal member 20 and the height of each of the pair of protrusions 11A, 11B. Accordingly, the seal member 20 is prevented from being elastically deformed excessively. Further, the maximum value of the elastic deformation amount of the seal member 20 can be changed by changing the height of each of the pair of protrusions 11A, 11B.

As described above, the nozzle protective cap 1 of the present embodiment includes: the base part 10 which has the facing surface 11 facing the nozzle surface 121 of the recording head 120 having the nozzle array 130 which is configured to eject the liquid droplets; the seal member 20 which is disposed in the facing surface 11 and which includes the elastic member configured to press the nozzle surface 121 in the state that the seal member 20 surrounds the nozzle array 130; the engaging parts 40A1, 40B1 of the pair of ball catches 40A, 40B which are configured to press the seal member 20 against the nozzle surface 121 and to engage with the recording head 120 so that the nozzle protective cap 1 and the recording head 120 are integrated; and the pair of bolts 50A, 50B which are configured to press the seal member 20 against the nozzle surface 121 and to engage with the recording head 120 to an extent stronger than the engaging parts 40A1, 40B1 of the pair of ball catches 40A, 40B engage with the recording head 120 so that the nozzle protective cap 1 and the recording head 120 are integrated.

In this manner, in the nozzle protective cap 1 of the present embodiment, the engaging parts 40A1, 40B1 of the pair of ball catches 40A, 40B are engaged, respectively, with the engagement receiving parts 40A2, 40B2 of the pair of ball catches 40A, 40B included in the head unit 100. With this, the nozzle protective cap 1 is attached to the head unit 100. The nozzle protective cap 1 can be easily attached and detached with respect to the head unit 100 even in a case where the nozzle protective cap 1 is required to be attached and detached repeatedly and frequently with respect to the head unit 100. Further, in a case where the pair of bolts 50A, 50B are fastened to the pair of nuts 150A, 150B included in the head unit 100, the nozzle protective cap 1 can be engaged with the head unit 100 more strongly as well.

Furthermore, the engaging parts 40A1, 40B1 of the pair of ball catches 40A, 40B have the forward ends which protrude from the facing surface 11 in the direction in which the facing surface 11 faces the nozzle surface 120. Accordingly, the user can attach the nozzle protective cap 1 to the head unit 100 while watching the forward ends.

Moreover, the engaging parts 40A1, 40B1 of the pair of ball catches 40A, 40B are disposed, respectively, at the positions at which the seal member 20 is interposed between the engaging parts 40A1 and 40B1, in the direction parallel to the facing surface 11. Accordingly, in a case where the nozzle protective cap 1 is attached to the head unit 100, the seal member 20 uniformly presses the nozzle surface 121 of the recording head 120 by the pair of ball catches 40A, 40B which are positioned on both sides. Therefore, the nozzle array 130 can be sealed properly.

Further, each of the pair of bolts 50A, 50B is disposed between the seal member 20 and one of the engaging parts 40A1, 40B1, of the pair of ball catches 40A, 40B, corresponding thereto, in the direction parallel to the facing surface 11. In this manner, the pair of bolts 50A, 50B are disposed at the positions nearer to the seal member 20, respectively, as compared with the engaging parts 40A1, 40B1 of the pair of ball catches 40A, 40B are. Accordingly, in a case where the nozzle protective cap 1 is engaged with the head unit 100 more strongly by using the pair of bolts 50A, 50B, the seal member 20 uniformly presses the nozzle surface 121 of the recording head 120 by the stronger force by the pair of bolts 50A, 50B positioned on both sides. Accordingly, the nozzle array 130 can be sealed more properly.

Further, the pair of protrusions 11A, 11B are formed on the facing surface 11. The pair of protrusions 11A, 11B are disposed, respectively, at the positions at which the seal member 20 is interposed between the pair of protrusions 11A, 11B in the direction parallel to the facing surface 11. The pair of bolts 50A, 50B are disposed so that the pair of bolts 50A, 50B can be exposed, respectively, from the protrusions 11A, 11B. Such a case is assumed that in a case where the nozzle protective cap 1 is attached to the head unit 100, the nozzle protective cap 1 is engaged with the recording head 120 more strongly by further using the pair of bolts 50A, 50B. In this situation, the pair of protrusions 11A, 11B, which have the predetermined heights from the facing surface 11, can prevent the seal member 20 from being elastically deformed excessively, owing to the heights of the pair of protrusions 11A, 11B.

Further, the balls 43, 44 of the ball catch 40A, 40B have the size in the range of 3 mm to 10 mm. Accordingly, the size of the ball catch 40A, 40B can be restricted. Therefore, the nozzle protective cap 1 which is compact can be produced.

As described above, the head unit 100 of the present embodiment is the head unit 100 configured so that the nozzle protective cap 1 can be attached and detached with respect to the head unit 100, the head unit 100 including: the recording head 120 which has the nozzle surface 121; the nozzle guide 122 which has the contact surfaces 122A, 122B configured to contact the facing surface 11 of the nozzle protective cap 1 and which surrounds the nozzle surface 121 of the recording head 120; and the engagement receiving parts 40A2, 40B2 of the pair of ball catches 40A, 40B which are configured to engage with the engaging parts 40A1, 40B1 of the pair of ball catches 40A, 40B.

In this manner, in the head unit 100 of the present embodiment, the engagement receiving parts 40A2, 40B2 of the pair of ball catches 40A, 40B, which are configured to engage with the engaging parts 40A1, 40B1 of the pair of ball catches 40A, 40B included in the nozzle protective cap 1, are engaged with the engaging parts 40A1, 40B1 of the pair of ball catches 40A, 40B. With this, the nozzle protective cap 1 is attached to the head unit 100. The nozzle protective cap 1 can be easily attached and detached with respect to the head unit 100 even in a case where the nozzle protective cap 1 is required to be attached and detached repeatedly and frequently with respect to the head unit 100. Further, in a case where the pair of bolts 50A, 50B are fastened to the pair of nuts 150A, 150B included in the head unit 100, the nozzle protective cap 1 can be engaged with the head unit 100 more strongly as well.

Furthermore, each of the contact surfaces 122A, 122B is disposed in the nozzle guide 122 so that the nozzle array 130 included in the nozzle surface 121 of the recording head 120 is interposed between the contact surfaces 122A, 122B in the direction in which the nozzle array 130 extends. Accordingly, the facing surface 11 of the nozzle protective cap 1 contacts the contact surfaces 122A, 122B, and the facing surface 11 does not contact the nozzle array 130 directly. Therefore, the nozzle array 130 can be prevented from being damaged.

Moreover, the engagement receiving parts 40A2, 40B2 of the pair of ball catches 40A, 40B have the forward ends which protrude from the contact surfaces 122A, 122B in the direction in which the liquid droplets are ejected from the recording head 120. Accordingly, the user can attach the nozzle protective cap 1 to the head unit 100 while watching the forward ends.

Further, the nozzle guide 122 has the pair of nuts 150A, 150B which are disposed at the portions facing, respectively, the pair of bolts 50A, 50B of the nozzle protective cap 1 and which are engageable, respectively, with the pair of bolts 50A, 50B in a case where the nozzle protective cap 1 is attached to the head unit 100. Accordingly, the nozzle protective cap 1 can be engaged with the head unit 100 more strongly by fastening the pair of bolts 50A, 50B included in the nozzle protective cap 1 to the pair of nuts 150A, 150B.

Furthermore, the pair of engagement receiving parts 40A2, 40B2 of the pair of ball catches 40A, 40B are disposed, respectively, at the positions at which the nozzle surface 121 is interposed between the pair of engagement receiving parts 40A2, 40B2 in the direction parallel to the nozzle surface 121. Each of the pair of nuts 150A, 150B is disposed, in the direction parallel to the nozzle surface 121, between the nozzle surface 121 and one of the engagements receiving parts 40A2, 40B2, of the pair of ball catches 40A, 40B, corresponding thereto. In this manner, the nut 150A of the pair of nuts 150A, 150B is disposed at the position nearer to the nozzle surface 121 as compared with the engagement receiving part 40A2 of the ball catch 40A of the pair of ball catches 40A, 40B; and the nut 150B of the pair of nuts 150A, 150B is disposed at the position nearer to the nozzle surface 121 as compared with the engagement receiving part 40B2 of the ball catch 40B of the pair of ball catches 40A, 40B. Accordingly, in a case where the nozzle protective cap 1 is engaged with the head unit 100 more strongly by using the pair of nuts 150A, 150B, the nozzle surface 121 is uniformly pressed by the stronger force against the seal member 20 included in the facing surface 11 of the nozzle protective cap 1 by the pair of nuts 150A, 150B positioned on the both sides. Accordingly, the nozzle array 130 can be sealed more properly.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

In the embodiment described above, the first engaging part is exemplified by the engaging parts 40A1, 40B1 of the pair of ball catches 40A, 40B, and the first engagement receiving part is exemplified by the engagement receiving parts 40A2, 40B2 of the pair of ball catches 40A, 40B. However, the present disclosure is not limited to this. The engagement receiving parts 40A2, 40B2 of the pair of ball catches 40A, 40B may be adopted as the first engaging part, and the engaging parts 40A1, 40B1 of the pair of ball catches 40A, 40B may be adopted as the first engagement receiving part. Further, the number of ball catches is not limited to two and may be three or more. Note, however, that in a case where the number is one, the sealing of the nozzle surface 21 by the seal member 20 might be incomplete. Furthermore, any catch other than the ball catch, for example, a roller catch or a magnet catch may be adopted. Moreover, the material of the ball of the ball catch is not limited as well, and the material may include, for example, balls made of metal and balls made of resin.

In the embodiment described above, the second engaging part is exemplified by the pair of bolts 50A, 50B, and the second engagement receiving part is exemplified by the pair of nuts 150A, 150B. However, the present disclosure is not limited to this. A male screw other than the bolt, for example, a screw may be adopted as the second engaging part, and a female screw other than the nut, for example, a threaded screw hole may be adopted as the second engagement receiving part. Further, the number of bolts is not limited to two as well, and the number may be three or more.

What is claimed is:

1. A nozzle protective cap comprising:
a base part having a facing surface configured to face a nozzle surface of a recording head having a nozzle array configured to eject liquid droplets;
a seal member positioned in the facing surface and including an elastic member configured to press the nozzle surface in a state that the seal member surrounds the nozzle array;
a first engaging part configured to press the seal member against the nozzle surface and to engage with the recording head so that the nozzle protective cap and the recording head are integrated; and
a second engaging part configured to press the seal member against the nozzle surface and to engage with the recording head to an extent stronger than the first engaging part engages with the recording head so that the nozzle protective cap and the recording head are integrated.

2. The nozzle protective cap according to claim 1, wherein
the first engaging part includes an engagement receiving part or an engaging part constructing a catch.

3. The nozzle protective cap according to claim 1, wherein
the second engaging part includes a male screw.

4. The nozzle protective cap according to claim 1, wherein
the first engaging part has a forward end protruding from the facing surface in a facing direction of the facing surface with respect to the nozzle surface.

5. The nozzle protective cap according to claim 4, wherein
the first engaging part includes a pair of engaging parts, and
the pair of engaging parts are positioned so that the seal member is interposed between the pair of engaging parts in a direction parallel to the facing surface.

6. The nozzle protective cap according to claim 5, wherein
the second engaging part includes a pair of engaging parts, and
each of the pair of engaging parts of the second engaging part is disposed between the seal member and one of the pair of engaging parts of the first engaging part in the direction parallel to the facing surface.

7. The nozzle protective cap according to claim 6, wherein
a pair of protrusions are formed on the facing surface,
the pair of protrusions are positioned so that the seal member is interposed between the pair of protrusions in the direction parallel to the facing surface, and
each of the pair of engaging parts of the second engaging part is exposed from one of the pair of protrusions.

8. The nozzle protective cap according to claim 2, wherein
the catch is a ball catch, and
a ball of the ball catch has a size in a range of 3 mm to 10 mm.

9. A head unit configured so that the nozzle protective cap as defined in claim 1 is attachable and detachable with respect to the head unit, the head unit comprising:
a recording head having the nozzle surface;
a nozzle guide having a contact surface configured to contact the facing surface of the nozzle protective cap and surrounding the nozzle surface of the recording head; and
a first engagement receiving part configured to engage with the first engaging part.

10. The head unit according to claim 9, wherein
contact surfaces including the contact surface are disposed in the nozzle guide so that the nozzle array included in the nozzle surface of the recording head is interposed between the contact surfaces in an extending direction of the nozzle array.

11. The head unit according to claim 10, wherein
a forward end of the first engagement receiving part protrudes from the contact surface in an ejection direction of the liquid droplets from the recording head.

12. The head unit according to claim 9, wherein
the nozzle guide has a second engagement receiving part disposed at a portion, of the nozzle guide, facing the second engaging part of the nozzle protective cap and configured to engage with the second engaging part in a case where the nozzle protective cap is attached to the head unit.

13. The head unit according to claim 12, wherein
the first engagement receiving part includes a pair of engagement receiving parts,
the pair of engagement receiving parts of the first engagement receiving part are positioned so that the nozzle surface is interposed between the pair of engagement receiving parts in a direction parallel to the nozzle surface,
the second engagement receiving part includes a pair of engagement receiving parts, and
each of the pair of engagement receiving parts of the second engagement receiving part is disposed between the nozzle surface and one of the pair of engagement receiving parts of the first engagement receiving part in the direction parallel to the nozzle surface.

14. A method of attaching a nozzle protective cap to a head unit so that the nozzle protective cap is attachable and detachable with respect to the head unit,
the nozzle protective cap being configured to be attached and detached with respect to the head unit, and the nozzle protective cap including: a base part having a facing surface configured to face a nozzle surface of a recording head including a nozzle array configured to eject liquid droplets; a seal member positioned in the facing surface and including an elastic member configured to press the nozzle surface in a state that the seal member surrounds the nozzle array; a first engaging part configured to press the seal member against the nozzle surface and to engage with the recording head so that the nozzle protective cap and the recording head are integrated; and a second engaging part configured to press the seal member against the nozzle surface and to engage with the recording head to an extent stronger than the first engaging part engages with the recording head so that the nozzle protective cap and the recording head are integrated, and
the head unit including the recording head having the nozzle surface, a nozzle guide having a contact surface configured to contact the facing surface of the nozzle protective cap and surrounding the nozzle surface of the recording head, and a first engagement receiving part configured to engage with the first engaging part,
the method comprising:
holding the first engaging part and the first engagement receiving part by a force of 40N or more so that the first engaging part and the first engagement receiving part are attracted to each other.
